(19) United States
(12) Patent Application Publication
(10) Pub. No.: US 2019/0014083 A1
(43) Pub. Date: Jan. 10, 2019

(54) URL FILTERING METHOD AND DEVICE

(71) Applicant: THOMSON Licensing, Issy-les-Moulineaux (FR)

(72) Inventors: Tianwen XU, Beijing (CN); HongLei ZHU, Beijing (CN)

(73) Assignee: THOMSON Licensing, Issy-les-Moulineaux (FR)

(21) Appl. No.: 16/065,809

(22) PCT Filed: Dec. 29, 2015
(86) PCT No.: PCT/CN2015/099333

§ 371 Date: Jun. 24, 2018

(51) Int. Cl. H04L 29/06; G06F 17/30; H04L 29/12

(52) U.S. Cl. CPC H04L 63/0236; G06F 17/30876; H04L 63/10; H04L 61/1511; H04L 61/3025

(57) ABSTRACT

The present disclosure discloses an IP address based URL filtering method, the method comprising: sniffing a network access request message for accessing a URL; querying an IP address filtering library, to determine whether a destination IP address of the network access request message exists in the IP address filtering library; and in response a query result indicating that the destination IP address exists in the IP address filtering library, discarding the network access request message.

### TECHNICAL FIELD

The present disclosure relates to network, and more particularly, to IP address based URL filtering method and electronic device implementing the method.

### BACKGROUND

In recent years, with the development of internet, there are more and more contents on the network, and network security gets more and more attention.

In many cases, a network administrator may want to control network access. For example, parents do not want their children to have access to URLs having inappropriate contents, a company's administrator does not want employees to access URLs unrelated to work using work computers at work time and so on. For this reason, a typically adopted manner is adding an unexpected URL to a backlist of URLs to filter out unexpected URL.

However, if a user already knows an IP address of a URL, then the existing approach cannot prevent an illegal access, because URL filtering in the existing approach is based on DNS resolution process, but in the case of knowing an IP address of a URL, DNS resolution is bypassed.

### SUMMARY OF THE INVENTION

According to an aspect of the present disclosure, there is provided an IP address based URL filtering method, comprising: sniffing a network access request message for accessing a URL; querying an IP address filtering library, to determine whether a destination IP address of the network access request message exists in the IP address filtering library; and

in response a query result indicating that the destination IP address exists in the IP address filtering library, discarding the network access request message.

According to another embodiment of the present application, there is provided an electronic device, comprising: a memory that stores computer readable instructions; and a processor, wherein the processor is configured to execute the computer readable instructions to implement an IP address based URL filtering method, the method comprising: sniffing a network access request message for accessing a URL; querying a IP address filtering library, to determine whether a destination IP address of the network access request message exists in the IP address filtering library; and in response a query result indicating that the destination IP address exists in the IP address filtering library, discarding the network access request message.

### BRIEF DESCRIPTION OF THE DRAWINGS

FIG. 1 is a flowchart of an IP address based URL filtering method according to a first embodiment of the present disclosure;

FIG. 2 is a flowchart of a first mode (active mode) of establishing an IP address filtering library;

FIG. 3 is a flowchart of a second mode (passive mode) of establishing an IP address filtering library;

FIG. 4 is a flowchart of establishing a Redirect IP address filtering library; and

FIG. 5 is system diagram of a system implementing one or more methods according to the present disclosure.

### DETAILED DESCRIPTION OF THE EMBODIMENTS

Hereinafter, the IP address based URL filtering method according to the embodiments of the present disclosure will be described with reference to the drawings, the method may be applied to devices such as Router, Gateway, Firewall, UTM (Unified Threat Management) device.

### First Embodiment

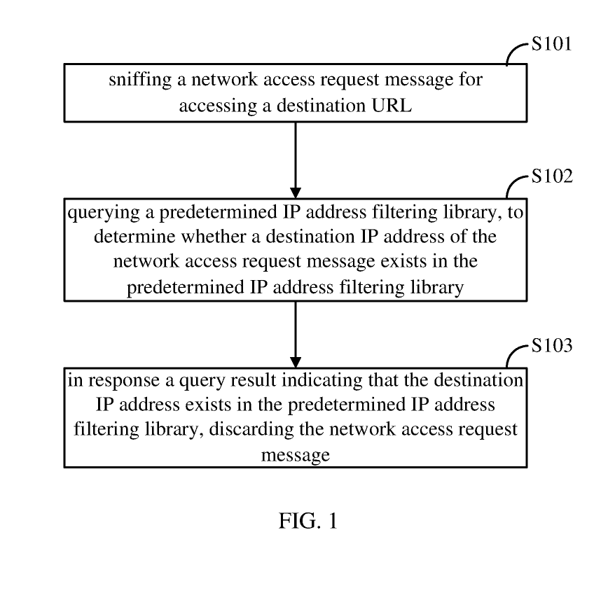

FIG. 1 is a flowchart of an IP address based URL filtering method according to a first embodiment of the present disclosure. In this embodiment, description is provided with a router as an example of the electronic device, as will be appreciated, the router is merely an example of the electronic device, not a limitation thereto.

Before describing the IP address based URL filtering method according to the embodiment of the present disclosure, process of DNS resolution will be briefed first.

For example, after the web user types “hackspc.com” in the address bar of web browser, firstly the web browser needs to retrieve the IP address of hackspc via Domain Name System (DNS), which can translate a human-readable domain name (e.g., hackspc.com) into an IP address that computers can use.

The web browser will send a DNS request message to DNS server, then the DNS server will send back a DNS response message which should contain the IP address of hackspc, here it assumes to be 67.228.216.16.

With this IP address 67.228.216.16, the web browser can access the web server of hackspc via HTTP protocol, after then the web user can see the home page of hackspc in the web browser, from here we can see that DNS resolving is an important step during the Internet accessing.

Now suppose a network administrator wants to control the web accessing, i.e., doesn't allow the web user to access some specific websites, assume this administrator would like to block website hackspc because it is a hacker website. He/she needs to add its Fully Qualified Domain Name (FQDN) “hackspc.com” or only the keyword “hackspc” into the Uniform Resource Locators (URL) blacklist of the outer router which has the capacity of URL filtering.

After adding, if an user attempts to access the website “hackspc.com” via a web browser, firstly the web browser will send a DNS request message to DNS server and expect to get the IP address of hackspc from the DNS response message. As we know, the current implementation mechanism of URL filtering is comparing the URL in DNS response message and the URLs in the blacklist, if matches, which means the URL in the DNS response message is prohibited, then the router will drop or maybe rewrite this DNS response message, which will cause the web browser can't get the expected IP address, consequently the web user fails to access the website hackspc.

But there is an issue in the above conventional solution. Suppose the web user obtains the IP address of hackspc from other sources (e.g., asking a friend or remember it or whatever means), if he/she directly inputs the numeric IP address of hackspc (67.228.216.16) iso the FQDN of hackspc (hackspc.com) in the address bar of the web browser, the web browser could recognize that this input is already a valid IP address, so that it will skip the DNS resolution process, and establish connection with the target web server (here it is hackspc) directly. As a result, the web user can access hackspc successfully. In this case, we fails to block this illegal access because we implement URL filtering based on DNS resolution process. In this case, DNS resolution is bypassed.

In order to solve the above problem, the IP address based URL filtering method according to the embodiment of the present disclosure is provided.

As shown in FIG. 1, the IP address based URL filtering method according to the embodiment of the present disclosure comprises the following steps:

step S101: sniffing a network access request message for accessing a URL;
step S102: querying a predetermined IP address filtering library, to determine whether a destination IP address of the network access request message exists in the predetermined IP address filtering library; and
step S103: in response a query result indicating that the destination IP address exists in the predetermined IP address filtering library, discarding the network access request message.

Specifically, in the case of applying the method according to the embodiment of the present disclosure to the router, in step S101, the router may receive a network access request sent by a user via a page browser.

For example, the network access request may be a http/https/ftp request message made by the user via a client device. If it is a TCP message, and if the destination port is 80, it is regarded as a http message. Else if the destination port is 443, it is regarded as a https message. Else if the destination port is 21, it is regarded as a ftp message.

After detecting the http/https/ftp message, the router continues to check whether its destination IP is found in the present IP filtering database (i.e., IP blacklist). If found, the router drops this message. Otherwise, if not found, the router forwards it as usual.

In an embodiment, it is assumed that the user inputs the URL of the destination website via the web browser, such as hackspc.com. in this case, the router monitors this network access request, transmits a DNS request message of the URL (i.e., hackspc.com) to a DNS server, receives and decodes a DNS response message returned from the DNS server, and extracts a destination IP address of the URL from an associated decoded DNS message.

In another embodiment, it is assumed that the user directly inputs an IP address of the URL via the web browser, such as 67.228.216.16. In this case, the router monitors this network access request, and in response to that the network access request message includes a destination IP address (i.e., 67.228.216.16) of the URL, it extracts the destination IP address (i.e., 67.228.216.16) of the URL from the network access request.

Thereafter, in step S102, the router may query a predetermined IP address filtering library, to determine whether a destination IP address of the network access request message exists in the predetermined IP address filtering library.

The method of establishing the IP address filtering library will be described in detail later.

Last, in step S103, in response a query result indicating that the destination IP address exists in the predetermined IP address filtering library, the network access request message the discarded.

In other words, when the destination IP address of the network access request is an IP address that needs to be filtered according to the IP address filtering library, the router considers the network access request as illegal, and therefore discards the network access request message.

As a result, no matter the users inputs the URL of the destination website or the IP address of the destination website, access to the illegal destination website can always be intercepted.

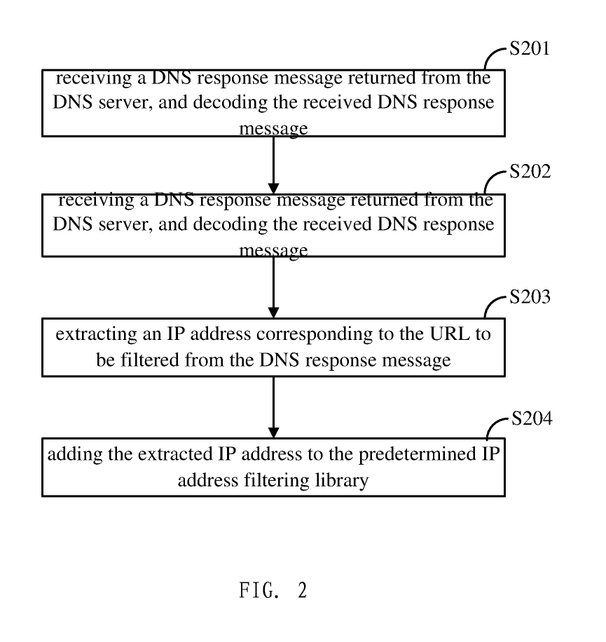

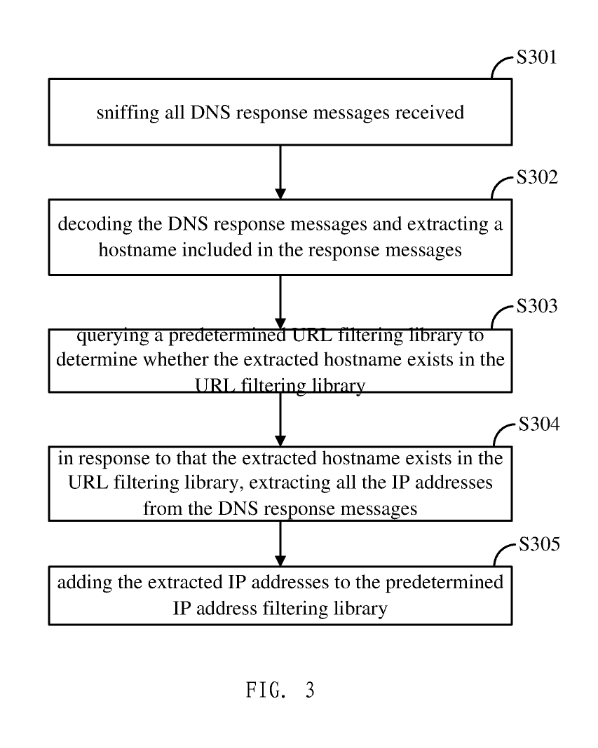

Next, two modes of establishing the IP address filtering library will be described in detail with reference to FIGS. 2 and 3.

FIG. 2 shows a first mode, i.e., an active mode, of establishing the IP address filtering library.

As shown in FIG. 2, the method of the active mode comprises the following steps:

step S201: in response to an operation of adding a URL to be filtered to a filtering list, transmitting a DNS request message of the URL to be filtered to the DNS server;
step S202: receiving a DNS response message returned from the DNS server, and decoding the received DNS response message;
step S203: extracting an IP address corresponding to the URL to be filtered from the DNS response message; and
step S204: adding the extracted IP address to the predetermined IP address filtering library.

Specifically, in step S201, when detecting an operation that the user adds a URL to be filtered to a filtering list, a DNS request message of the URL to be filtered is transmitted to the DNS server.

It should be noted that, in this step, first the router checks if it is a FQDN (fully qualified domain name) e.g., www.sohu.com or only a keyword with or without wildcard character, e.g., *sohu*. And if it is only a keyword, the router needs to create FQDN based on the keyword inputted by the user. Normally, it concatenates below three parts to create a FQDN: www+keyword+domain suffix, and the generic domain suffix includes one of “.com, .net, .org, .gov, .edu, etc”. Suppose the keyword is abc, the final FQDNs could be www.abc.com, www.abc.net, www.abc.org, www.abc.gov, www.abc.edu, . . . .

After a FQDN is generated, the router can send out a DNS request message with this FQDN to DNS server.

Thereafter, in step S202, the router may receive a DNS response message returned from the DNS server, and decode the received DNS response message.

It should be noted that, prior to extracting the IP address from the DNS response message, it may determine whether the DNS response message is a valid DNS message; and in response to that an amount of the IP address included in the DNS response messages is larger than or equal to 1, it is determined that the DNS response message is a valid DNS message.

Next, in step S203, when it is determined that the DNS response message is the valid DNS message, the router may extract an IP address corresponding to the URL to be filtered from the DNS response message.

Last, the router may add the extracted IP address to the predetermined IP address filtering library. In this way, the router can initiatively transmit the URL in the URL list to the DNS server and extract an IP address corresponding to the URL from the DNS response message, the router thereby initiatively establish an IP address blacklist.

FIG. 3 shows a second mode, i.e., a passive mode, of establishing an IP address filtering library.

As shown in FIG. 3, the method of the passive mode comprises the following steps:

step S301: sniffing all DNS response messages received;
step S302: decoding the DNS response messages and extracting a hostname included in the response messages;
step S303: querying a predetermined URL filtering library to determine whether the extracted hostname exists in the URL filtering library;
step S304: in response to that the extracted hostname exists in the URL filtering library, extracting all the IP addresses from the DNS response messages; and
step S305: adding the extracted IP addresses to the predetermined IP address filtering library.

Specifically, in step S301, the router sniffs all DNS response messages received. In particular, when there is one or more users, the user may sniff all DNS response message of all the users.

Thereafter, in step S302, the router decodes the DNS response messages and extracting a hostname included in the response messages. In particular, the DNS response message includes multiple fields, for example, the IP address of the URL, the hostname of the URL etc.

It should be noted that, usually, the extracted hostname is the same as the URL of the destination network address, but in some cases, for example when the user inputs keywords to access a network, the hostname in the DNS response message is a correct, complete URL of the network address.

Thereafter, in step S303, the router queries a predetermined URL filtering library to determine whether the extracted hostname exists in the URL filtering library.

Thereafter, in step S304, in response to that the extracted hostname exists in the URL filtering library, the router extracts all the IP addresses from the DNS response messages.

Thereafter, in step S305, the router adds the extracted IP addresses to the predetermined IP address filtering library.

In this way, the router passively sniffs all the DNS response messages received, extract a hostname from the DNS response messages, and compares the hostname with the URL blacklist, when there is a match, all the IP addresses in the DNS messages as the IP address that need to be intercepted. As a result, the router passively establishes an IP address blacklist.

However, there is a side effect in current Internet environment. Now let's suppose a ISP's DNS server receives a request for an URL name that is not recognized or is unavailable, in theory DNS server should return a null (not found) message to client. But nowadays for the purpose of business, some ISPs spoof the NX (null) response and instead return the IP address of a search or advertising page to the client. When the client is using a web browser, which will display a search page that contains possible suggestions on the proper address and a small explanation of the error. These search pages often contain advertising that is paid to the ISP.

For easy understanding, suppose a web user attempts to access an unavailable URL (e.g., www.abc.gov) via web browser, the DNS server can't find the associated IP address and should return null, but this DNS server spoofs the null response and instead returns an IP address of search page (e.g., google), the router sniffs this DNS response message and finds that the hostname (here it is www.abc.gov) in this message is matched in URL blacklist (match *abc*) which configured by administrator, so that extract the IP addresses (in fact it is google's IP) and insert them into IP blacklist. Therefore, the google's IP is inserted into IP blacklist. Consequently, the user will fail to access google. Obviously, this is not what the user expected.

Accordingly, the method according to the embodiment of the present disclosure may further comprise:

prior to adding the extracted IP address to the predetermined IP address filtering library, checking whether the extracted IP address exists in a Redirect IP address library, which stores an IP address contained in a DNS response message returned from the DNS server when an unavailable URL is transmitted to the DNS server; and
in response to that the extracted IP address does not exist in the Redirect IP address library, adding the extracted IP address to the predetermined IP address filtering library.

Normally the spoofed/redirected IP address of a DNS server is fixed during a period, the router could detect this IP via sending DNS request actively with unavailable URLs to DNS server and retrieve the spoofed IP address from the DNS response message. The next problem is how to construct an unavailable URL.

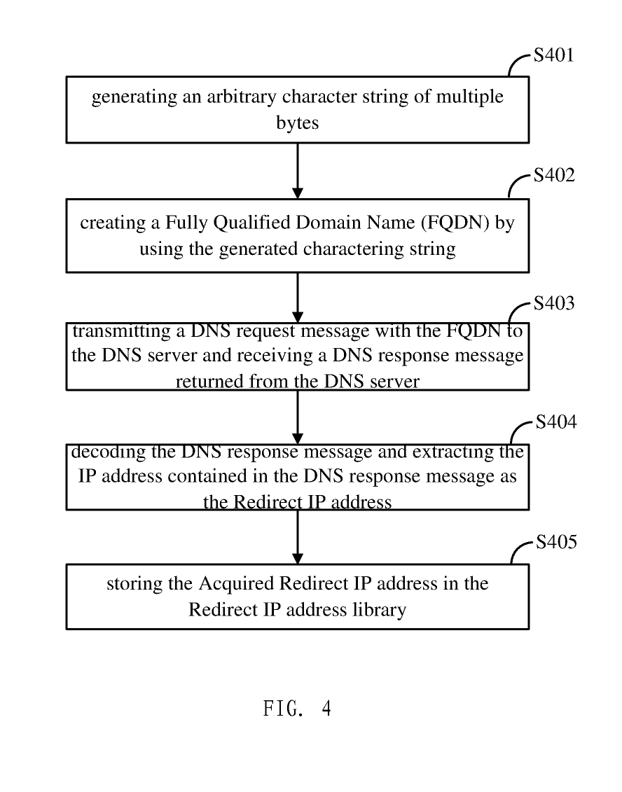

The method of establishing the Redirect IP address library will be described in detail below with reference to FIG. 4.

As shown in FIG. 4, the method according to the embodiment of the present disclosure comprises:

step S401: generating an arbitrary character string of multiple bytes;
step S402: creating a Fully Qualified Domain Name (FQDN) by using the generated charactering string;
step S403: transmitting a DNS request message with the FQDN to the DNS server and receiving a DNS response message returned from the DNS server;
step S404: decoding the DNS response message and extracting the IP address contained in the DNS response message as the Redirect IP address; and
step S405: storing the Acquired Redirect IP address in the Redirect IP address library.

Specifically, in step S401, for example, the router can generate a random 32-bytes character string. For convenience, the router can make use of an utility md5sum to help to generate an unavailable URL, for example:

root@OpenWrt:/# md5sum/bin/1s
8fcaab7c90ec0acf923742f99fef1d37/bin/1s

Thereafter, in step S402, a Fully Qualified Domain Name (FQDN) is created by using the generated charactering string. For example, the unavailable URL could be www.8fcaab7c90ec0acf923742f99fef1d37.com.

Thereafter, in step S403, the router may transmit a DNS request with the FQDN to the DNS server and receive a DNS response message returned from the DNS server.

next, in step S40, the router may decode the DNS response message and extract the IP address contained in the DNS response message as the Redirect IP address.

Last, in step S405, the router stores the Acquired Redirect IP address in the Redirect IP address library.

In another embodiment, prior to storing the Acquired Redirect IP address in the Redirect IP address library, the step of acquiring the Redirect IP address may be repeated multiple times, to acquire multiple Redirect IP addresses. In response to that the acquired multiple Redirect IP addresses are the same, the Redirect IP address is stored in the Redirect IP address library.

For the sake of safety, the router can construct different unavailable URLs and send them to a same DNS server (for example, 3 unavailable URLs), decode the DNS response and extract the IP address. If the IP addresses in these 3 DNS response are same, the router can make sure that this IP address is a spoofed/redirected IP, so add this IP into Redirect IP List.

Accordingly, the IP address based filtering method and the electronic device according to the embodiments of the present disclosure can implement URL filtering based on IP address, and thereby provide better safety.

### Second Embodiment

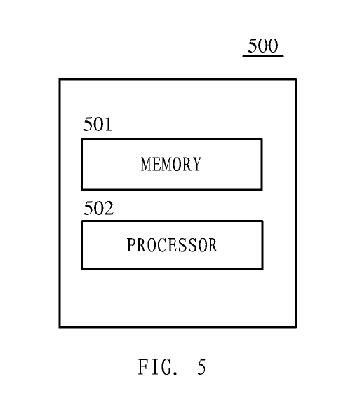

Hereinafter, an electronic device according to an embodiment of the present disclosure will be described with reference to FIG. 5. The electronic device may be devices such as Router, Gateway, Firewall, UTM (Unified Threat Management).

The electronic device 500 according to the embodiment of the present disclosure comprises:

a memory 501 that stores computer readable instructions; and
a processor 502,
wherein the processor 502 is configured to execute the computer readable instructions to implement an IP address based URL filtering method, the method comprising:
sniffing a network access request message for accessing a URL;
querying a predetermined IP address filtering library, to determine whether a destination IP address of the network access request message exists in the predetermined IP address filtering library; and
in response a query result indicating that the destination IP address exists in the predetermined IP address filtering library, discarding the network access request message.

Optionally, the destination IP address is obtained by the following mode:

transmitting a DNS request message of the URL to a DNS server, receiving and decoding a DNS response message returned from the DNS server, and extracting a destination IP address of the URL from an associated decoded DNS message; or
in response to that the network access request message includes a destination IP address of the URL, extracting the destination IP address of the URL from the network access request.

Optionally, the predetermined IP address filtering library is set up by the following mode:

in response to an operation of adding a URL to be filtered to a filtering list, transmitting a DNS request message of the URL to be filtered to the DNS server;
receiving a DNS response message returned from the DNS server, and decoding the received DNS response message;
extracting an IP address corresponding to the URL to be filtered from the DNS response message; and
adding the extracted IP address to the predetermined IP address filtering library.

Optionally, the predetermined IP address filtering library is set up by the following mode:

sniffing all DNS response messages received;
decoding the DNS response messages and extracting a hostname included in the response messages;
querying a predetermined URL filtering library to determine whether the extracted hostname exists in the URL filtering library;
in response to that the extracted hostname exists in the URL filtering library, extracting all the IP addresses from the DNS response messages; and
adding the extracted IP addresses to the predetermined IP address filtering library.

Optionally, the processor 502 is further configured to execute steps of:

prior to extracting the IP address from the DNS response message, determining whether the DNS response message is a valid DNS message; and
in response to that an amount of the IP address included in the DNS response messages is larger than or equal to 1, determining that the DNS response message is a valid DNS message.

Optionally, the processor 502 is further configured to execute steps of:

prior to adding the extracted IP address to the predetermined IP address filtering library, checking whether the extracted IP address exists in a Redirect IP address library, which stores an IP address contained in a DNS response message returned from the DNS server when an unavailable URL is transmitted to the DNS server; and
in response to that the extracted IP address does not exist in the Redirect IP address library, adding the extracted IP address to the predetermined IP address filtering library.

Optionally, the Redirect IP address library is set up by the following mode:

generating an arbitrary character string of multiple bytes;
creating a Fully Qualified Domain Name (FQDN) by using the generated charactering string;
transmitting a DNS request message with the FQDN to the DNS server and receiving a DNS response message returned from the DNS server;
decoding the DNS response message and extracting the IP address contained in the DNS response message as the Redirect IP address; and
storing the Acquired Redirect IP address in the Redirect IP address library.

Optionally, the processor 502 is further configured to execute steps of:

prior to storing the Acquired Redirect IP address in the Redirect IP address library, repeating the step of acquiring the Redirect IP address multiple times, to acquire multiple Redirect IP addresses;
in response to that the acquired multiple Redirect IP addresses are the same, storing the Redirect IP address in the Redirect IP address library.

Of course, the electronic device 500 may further comprise a network terminal, an input device and so on as needed.

Accordingly, the electronic device implementing the IP address based filtering method according to the embodiment of the present disclosure can implement URL filtering based on IP address, and thereby provide better safety.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

For example, in some embodiments, the present disclosure provides a non-transitory computer readable medium having computer readable instructions embodied therein, the computer readable medium instructions being configured to implement the preceding method when executed. The method includes: sniffing a network access request message for accessing a URL;

querying a predetermined IP address filtering library, to determine whether a destination IP address of the network access request message exists in the predetermined IP address filtering library; and
in response a query result indicating that the destination IP address exists in the predetermined IP address filtering library, discarding the network access request message.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1-16. (canceled)

17. A URL filtering method, comprising:
sniffing a network access request message for accessing a URL;
querying an IP address filtering library to determine whether a destination IP address of the network access request message exists in the IP address filtering library; and
in response a query result indicating that the destination IP address exists in the IP address filtering library, discarding the network access request message,
wherein the IP address filtering library is set up by:
in response to an operation of adding a URL to be filtered to a filtering list, transmitting a DNS request message of the URL to be filtered to the DNS server;
receiving a DNS response message returned from the DNS server, and decoding the received DNS response message;
extracting an IP address corresponding to the URL to be filtered from the DNS response message; and
adding the extracted IP address to the IP address filtering library.

18. The method according to claim 17, wherein the destination IP address is obtained by:
transmitting a DNS request message of the URL to a DNS server, receiving and decoding a DNS response message returned from the DNS server, and extracting a destination IP address of the URL from an associated decoded DNS message; or
in response to that the network access request message includes a destination IP address of the URL, extracting the destination IP address of the URL from the network access request.

19. The method according to claim 17, wherein the IP address filtering library is further set up by:
sniffing all DNS response messages received;
decoding the DNS response messages and extracting a hostname included in the response messages;
querying a predetermined URL filtering library to determine whether the extracted hostname exists in the URL filtering library;
in response to that the extracted hostname exists in the URL filtering library, extracting all the IP addresses from the DNS response messages; and
adding the extracted IP addresses to the IP address filtering library.

20. The method according to claim 19, further comprising:
prior to extracting the IP address from the DNS response message, determining whether the DNS response message is a valid DNS message; and
in response to that an amount of the IP address included in the DNS response messages is larger than or equal to 1, determining that the DNS response message is a valid DNS message.

21. The method according to claim 19, further comprising:
prior to adding the extracted IP address to the IP address filtering library, checking whether the extracted IP address exists in a Redirect IP address library, which stores an IP address contained in a DNS response message returned from the DNS server when an unavailable URL is transmitted to the DNS server; and
in response to that the extracted IP address does not exist in the Redirect IP address library, adding the extracted IP address to the IP address filtering library.

22. The method according to claim 21, wherein the Redirect IP address library is set up by:
generating an arbitrary character string of multiple bytes;
creating a Fully Qualified Domain Name (FQDN) by using the generated charactering string;
transmitting a DNS request message with the FQDN to the DNS server and receiving a DNS response message returned from the DNS server;
decoding the DNS response message and extracting the IP address contained in the DNS response message as the Redirect IP address; and
storing the acquired Redirect IP address in the Redirect IP address library.

23. The method according to claim 22, further comprising:
prior to storing the acquired Redirect IP address in the Redirect IP address library, repeating the steps of acquiring the Redirect IP address multiple times, to acquire multiple Redirect IP addresses;
in response to that the acquired multiple Redirect IP addresses are the same, storing the Redirect IP address in the Redirect IP address library.

24. A device for filtering URL, comprising:
a memory that stores computer readable instructions; and
a processor,
wherein the processor is configured to execute the computer readable instructions to implement:
sniffing a network access request message for accessing a URL;
querying a IP address filtering library, to determine whether a destination IP address of the network access request message exists in the IP address filtering library; and
in response a query result indicating that the destination IP address exists in the IP address filtering library, discarding the network access request message;
wherein the processor is further configured to execute the computer readable instructions to implement one of following approaches to set up the IP address filter library:
in response to an operation of adding a URL to be filtered to a filtering list, transmitting a DNS request message of the URL to be filtered to the DNS server;
receiving a DNS response message returned from the DNS server, and decoding the received DNS response message;
extracting an IP address corresponding to the URL to be filtered from the DNS response message; and
adding the extracted IP address to the IP address filtering library.

25. The device according to claim 24, wherein the destination IP address is obtained by:
transmitting a DNS request message of the URL to a DNS server, receiving and decoding a DNS response message returned from the DNS server, and extracting a destination IP address of the URL from an associated decoded DNS message; or
in response to that the network access request message includes a destination IP address of the URL, extracting the destination IP address of the URL from the network access request.

26. The device according to claim 24, wherein the IP address filtering library is further set up by:
sniffing all DNS response messages received;
decoding the DNS response messages and extracting a hostname included in the response messages;
querying a predetermined URL filtering library to determine whether the extracted hostname exists in the URL filtering library;
in response to that the extracted hostname exists in the URL filtering library, extracting all the IP addresses from the DNS response messages; and
adding the extracted IP addresses to the IP address filtering library.

27. The device according to claim 25, wherein the processor is further configured to execute steps of:
prior to extracting the IP address from the DNS response message, determining whether the DNS response message is a valid DNS message; and
in response to that an amount of the IP address included in the DNS response messages is larger than or equal to 1, determining that the DNS response message is a valid DNS message.

28. The device according to claim 25, wherein the processor is further configured to execute:
prior to adding the extracted IP address to the IP address filtering library, checking whether the extracted IP address exists in a Redirect IP address library, which stores an IP address contained in a DNS response message returned from the DNS server when an unavailable URL is transmitted to the DNS server; and
in response to that the extracted IP address does not exist in the Redirect IP address library, adding the extracted IP address to the IP address filtering library.

29. The device according to claim 28, wherein the Redirect IP address library is set up by:
generating an arbitrary character string of multiple bytes;
creating a Fully Qualified Domain Name (FQDN) by using the generated charactering string;
transmitting a DNS request message with the FQDN to the DNS server and receiving a DNS response message returned from the DNS server;
decoding the DNS response message and extracting the IP address contained in the DNS response message as the Redirect IP address; and
storing the acquired Redirect IP address in the Redirect IP address library.

30. The device according to claim 29, wherein the processor is further configured to execute steps of:
prior to storing the acquired Redirect IP address in the Redirect IP address library, repeating the steps of acquiring the Redirect IP address multiple times, to acquire multiple Redirect IP addresses;
in response to that the acquired multiple Redirect IP addresses are the same, storing the Redirect IP address in the Redirect IP address library.

31. Computer program product which is stored on a non-transitory computer readable medium and comprises program code instructions executable by a processor for implementing a method according to claim 17.

32. A non-transitory computer readable storage medium comprising program code instructions executable by a processor for implementing the steps of a method according to claim 17.
